(19) United States
(12) Patent Application Publication
(10) Pub. No.: US 2015/0036743 A1
(43) Pub. Date: Feb. 5, 2015

(54) INTERLAYER PREDICTION METHOD AND DEVICE FOR IMAGE SIGNAL

(71) Applicant: ELECTRONICS AND TELECOMMUNICATIONS RESEARCH INSTITUTE, Daejeon (KR)

(72) Inventors: Ha Hyun Lee, Seoul (KR); Jung Won Kang, Daejeon (KR); Jin Soo Choi, Daejeon (KR); Jin Woong Kim, Daejeon (KR)

(73) Assignee: ELECTRONICS AND TELECOMMUNICATIONS RESEARCH INSTITUTE, Daejeon (KR)

(21) Appl. No.: 14/374,488

(22) PCT Filed: Feb. 1, 2013
(86) PCT No.: PCT/KR2013/000850

§ 371 Date: Jul. 24, 2014

(30) Foreign Application Priority Data
Feb. 2, 2012 (KR) 10-2012-0010758
Feb. 1, 2013 (KR) 10-2013-0011950

(51) Int. Cl. H04N 19/593; H04N 19/33

(52) U.S. Cl. CPC H04N 19/00763; H04N 19/00436
USPC 375/240.12

(57) ABSTRACT

The present invention relates to a multilayer structure-based image coding and decoding method. The present invention provides a method of using an intra prediction mode of a corresponding block of a lower layer in intra-frame predictive coding of a target block of an upper layer to increase coding efficiency and decrease complexity by removing redundancy from inter-layer intra prediction mode information.

### TECHNICAL FIELD

The present invention concerns an image encoding and decoding method, and more specifically, to a layer structure-based image encoding and decoding method.

### BACKGROUND ART

Conventional scalable video coding adopts inter-layer texture prediction, inter-layer motion information prediction, and inter-layer residual signal prediction technologies so as to remove duplication that exists between layers. However, no technologies are used to remove duplication between intra prediction modes information respectively possessed by the layers. Further, in the current HEVC standards, more intra prediction modes are used than in the existing H.264 standard. The HEVC intra prediction mode is not designed to envision the multi-layer structure and accordingly demands more improvements so that it may be applicable to a video encoder/decoder having a HEVC-based multi-layer structure.

### DISCLOSURE

### Technical Problem

An object of the present invention is to provide a multiple layer structure-based image encoding and decoding method that removes duplication for inter-layer intra prediction mode information when performing intra-prediction encoding on an encoding target block of an upper layer, thereby increasing encoding efficiency while reducing complexity.

### Technical Solution

The present invention provides a multi-layer structure image decoding method, wherein the multi-layer structure having a first layer including a current encoding target block and a second layer that is a layer lower than the first layer, the method comprising the steps of determining a corresponding block in the second layer corresponding to the encoding target block and encoding the encoding target block using an intra prediction mode of the corresponding block in the second layer.

The step of determining the corresponding block in the second layer may specify a sample position of the corresponding block in the second layer corresponding to a reference sample position of the encoding target block in consideration of a scaling factor between input images.

The step of encoding the encoding target block using the intra prediction mode of the corresponding block in the second layer may be performed when the corresponding block in the second layer has been encoded in the intra prediction mode.

In case the corresponding block in the second layer is not available or in case the corresponding block has been inter predicted, the encoding target block may be encoded through a typical intra prediction scheme in the first layer.

In case the corresponding block in the second layer is not available or in case the corresponding block has been inter predicted, the intra prediction mode of the corresponding block in the second layer may be considered as a predetermined intra prediction mode (e.g., DC mode) and may be used for encoding the encoding target block.

The step of encoding the encoding target block may generate a prediction signal of the encoding target block using the intra prediction mode of the corresponding block in the second layer.

The step of encoding the encoding target block may use the intra prediction mode of the corresponding block in the second layer as an MPM (Most Probable Mode) candidate mode of the encoding target block.

The step of encoding the encoding target block may replace the intra prediction mode of at least one of an upper neighboring block and a left neighboring block of the encoding target block that is an MPM target block, as the intra prediction mode of the second layer corresponding block.

The step of encoding the encoding target block may use, as an MPM candidate mode, the intra prediction mode of the second layer corresponding block together with the intra prediction modes of the upper and left neighboring blocks of the encoding target block that is an MPM target block.

Further, the present invention provides a multi-layer structure image decoding method, wherein the multi-layer structure having a first layer including a current decoding target block and a second layer that is lower than the first layer, the method comprising the step of decoding the decoding target block using an intra prediction mode of the second layer block.

The multi-layer structure image decoding method may specify the corresponding block in the second layer by specifying a sample position of the second layer corresponding to the reference sample position of the decoding target block in consideration of a scaling factor between input images.

The step of decoding the decoding target block further includes the step of determining whether the decoding target block has used the intra prediction mode of the second layer block. The decoding step may decode the decoding target block using the intra prediction mode of the second layer in a case where the decoding target block has used the intra prediction mode of the second layer. The decoding step may perform decoding through a typical intra prediction decoding scheme in case the decoding target block does not use the intra prediction mode of the second layer.

The step of determining whether to have used the intra prediction mode of the second layer corresponding block may be performed on the basis of SPS (Sequence Parameter Sets), PPS (Picture Parameter Sets), Slice Segment header, coding unit, or prediction unit.

The step of decoding the decoding target block may generate a prediction signal of the decoding target block using the intra prediction mode of the second layer corresponding block.

The step of decoding the decoding target block may use the intra prediction mode of the second layer corresponding block as an MPM (Most Probable Mode) candidate mode of the decoding target block.

The step of decoding the decoding target block may replace the intra prediction mode of at least one of an upper neighboring block and a left neighboring block of the decoding target block that is an MPM target block with the intra prediction mode of the second layer corresponding block.

The step of decoding the decoding target block may use, as MPM candidate modes, the intra prediction mode of the sec and layer corresponding block, together with the intra prediction modes of the upper neighboring block and left neighboring block of the decoding target block that is an MPM target block.

The present invention provides a computer readable recording medium storing a program for executing in a computer a multi-layer structure image encoding method, wherein the multi-layer structure having a first layer including a current encoding target block and a second layer that is a reference lower layer of the first layer, the method comprising the steps of determining a corresponding block in the second layer corresponding to the encoding target block and encoding the encoding target block using an intra prediction mode of the corresponding block in the second layer and a multi-layer structure image decoding method, wherein the multi-layer structure having a first layer including a current decoding target block and a second layer that is a reference lowered layer of the first layer, the method comprising the step of decoding the decoding target block using the intra prediction mode of the second layer block.

Further, the present invention provides a multi-layer structure image encoding apparatus, wherein the multi-layer structure having a first layer including a current encoding target block and a second layer that is a reference lowered layer of the first layer, the apparatus including an intra predicting unit that encodes the encoding target block using an intra prediction mode of the second layer corresponding block.

The intra predicting unit may specify the second layer block corresponding to the encoding target block by specifying a sample position of the second layer corresponding to a reference sample position of the encoding target block in consideration of a scaling factor between input images.

The intra predicting unit may encode the encoding target block using the intra prediction mode of the second layer block in case the second layer block is encoded in the intra prediction mode.

In case the corresponding block in the second layer is not available or in case the corresponding block has been inter predicted, the encoding target block may be encoded through a typical intra prediction scheme in the first layer.

In case the corresponding block in the second layer is not available or in case the corresponding block is inter predicted, the intra prediction mode of the corresponding block in the second layer may be considered as a predetermined intra prediction mode (e.g., DC mode) and may be used for encoding the encoding target block.

The intra predicting unit may generate a prediction signal of the encoding target block using the intra prediction mode of the corresponding block in the second layer.

The intra predicting unit may use the intra prediction mode of the second layer corresponding block as an MPM (Most Probable Mode) candidate mode of the encoding target block.

The step of encoding the encoding target block may replace the intra prediction mode of at least one of an upper neighboring block and a left neighboring block of the encoding target block that is an MPM target block with the intra prediction mode of the second corresponding block.

The step of encoding the encoding target block may use as MPM candidate modes the intra prediction mode of the second layer corresponding block together with the intra prediction modes of the upper neighboring block and left neighboring block of the encoding target block that is an MPM target block.

Further, the present invention provides a multi-layer structure image decoding apparatus, wherein the multi-layer structure having a first layer including a current decoding target block and a second layer that is a reference lowered layer of the first layer, the apparatus comprising an intra predicting unit that decodes the decoding target block using an intra prediction mode of the second layer block.

The step of determining whether to have used the intra prediction mode of the second layer corresponding block is further provided. The decoding step may decode the decoding target block using the intra prediction mode of the second layer in case the decoding target block has used the intra prediction mode of the second layer. The decoding step may perform decoding through a typical intra prediction decoding scheme in case the decoding target block has not used the intra prediction mode of the second layer.

The step of determining whether to have used the intra prediction mode of the second layer corresponding block may be performed on the basis of SPS(Sequence Parameter Sets), PPS (Picture Parameter Sets), Slice Segment header, coding unit, or prediction unit.

The intra predicting unit may specify the second layer corresponding block corresponding to the decoding target block by specifying a sample position of the second layer corresponding to a reference sample position of the decoding target block in consideration of a scaling factor between input images.

The intra predicting unit may decode the decoding target block using the intra prediction mode of the second layer block in case the decoding target block has been encoded using the intra prediction mode of the second layer.

The intra predicting unit may perform decoding through a typical intra prediction decoding scheme in case the decoding target block has not used the intra prediction mode of the second layer.

The intra predicting unit may generate a prediction signal of the decoding target block using the intra prediction mode of the second layer block.

The intra predicting unit may use the intra prediction mode of the second layer block as an MPM (Most Probable Mode) candidate mode of the decoding target block.

The step of decoding the decoding target block may replace the intra prediction mode of at least one of an upper neighboring block and a left neighboring block of the decoding target block that is an MPM target block with the intra prediction mode of the second layer corresponding block.

The step of decoding the decoding target block may use as MPM candidate modes the intra prediction mode of the second corresponding block together with the intra prediction modes of the upper neighboring block and the left neighboring block of the decoding target block that is an MPM target block.

### Advantageous Effects

According to the present invention, the multiple layer structure-based image encoding and decoding method provides a method of using an intra prediction mode of a corresponding block of a lower layer when performing intra prediction encoding on an encoding target block of an upper layer to remove duplication for inter-layer intra prediction mode information, thus enhancing encoding efficiency while reducing complexity.

### DESCRIPTION OF DRAWINGS

FIGS. 1a and 1b are block diagrams illustrating configurations of image encoding apparatuses according to embodiments of the present invention.

FIGS. 2a and 2b are block diagrams illustrating configurations of image decoding apparatuses according to an embodiment of the present invention.

FIG. 3 is a flowchart illustrating a multi-layer structure image encoding method according to an embodiment of the present invention.

FIG. 4 is a view illustrating a relationship between an encoding target block and a lower layer block corresponding to the encoding target block in a multi-layer structure image encoding method according to an embodiment of the present invention.

FIG. 5 is a view illustrating generating a prediction signal of the encoding target block using an intra prediction mode of the lower layer block in a multi-layer structure image encoding method according to an embodiment of the present invention.

FIG. 6 is a view illustrating an example where all information of neighboring blocks of an encoding target block cannot be used.

FIG. 7 is a view illustrating an example where information of a left neighboring block used as an MPM candidate mode of an encoding target block is not available.

FIG. 8 is a view illustrating an example where index information of a left neighboring block used as MPM information of an encoding target block is the same as information of an upper neighboring block.

FIG. 9 is a view illustrating an example where an intra prediction mode of an upper neighboring block of an encoding target block is different from an intra prediction mode of a left neighboring block.

FIG. 10 is a view illustrating an example where an intra prediction mode of an upper neighboring block of an encoding target block is different from an intra prediction mode of a left neighboring block.

FIG. 11 is a flowchart illustrating a multi-layer structure image decoding method according to an embodiment of the present invention.

### BEST MODE

Various modifications may be made to the present invention and the present invention may have a number of embodiments. Specific embodiments are described in detail with reference to the drawings.

However, the present invention is not limited to specific embodiments, and it should be understood that the present invention includes all modifications, equivalents, or replacements that are included in the spirit and technical scope of the present invention.

The terms “first” and “second” may be used to describe various components, but the components are not limited thereto. These terms are used only to distinguish one component from another. For example, the first component may be also named the second component, and the second component may be similarly named the first component. The term “and/or” includes a combination of a plurality of related items as described herein or any one of the plurality of related items.

When a component is “connected” or “coupled” to another component, the component may be directly connected or coupled to the other component. In contrast, when a component is directly connected or coupled to another component, no component intervenes.

The terms used herein are given to describe the embodiments but not intended to limit the present invention. A singular term includes a plural term unless otherwise stated. As used herein, the terms “include” or “have” are used to indicate that there are features, numerals, steps, operations, components, parts or combinations thereof as described herein, but do not exclude the presence or possibility of addition of one or more features, numerals, steps, operations, components, parts or components thereof.

Unless defined otherwise, all the terms used herein including technical and scientific terms have the same meaning as generally understood by those skilled in the art. The terms as generally used and defined in the dictionary should be understood as having the same meaning as understood in the context, and unless clearly defined herein, but not should be construed in an ideal or excessive manner.

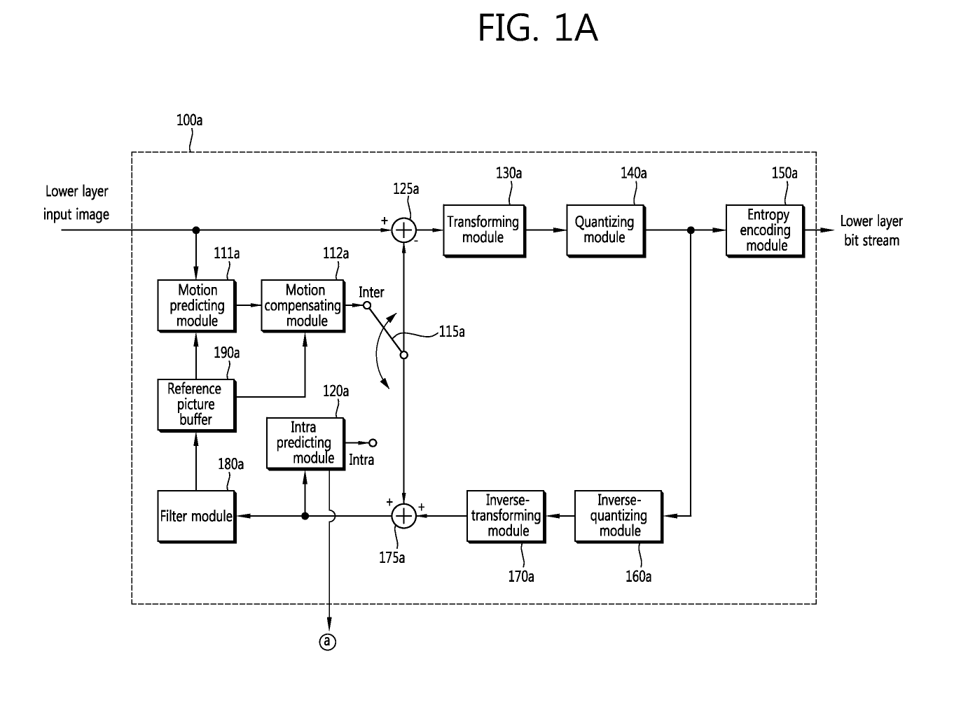

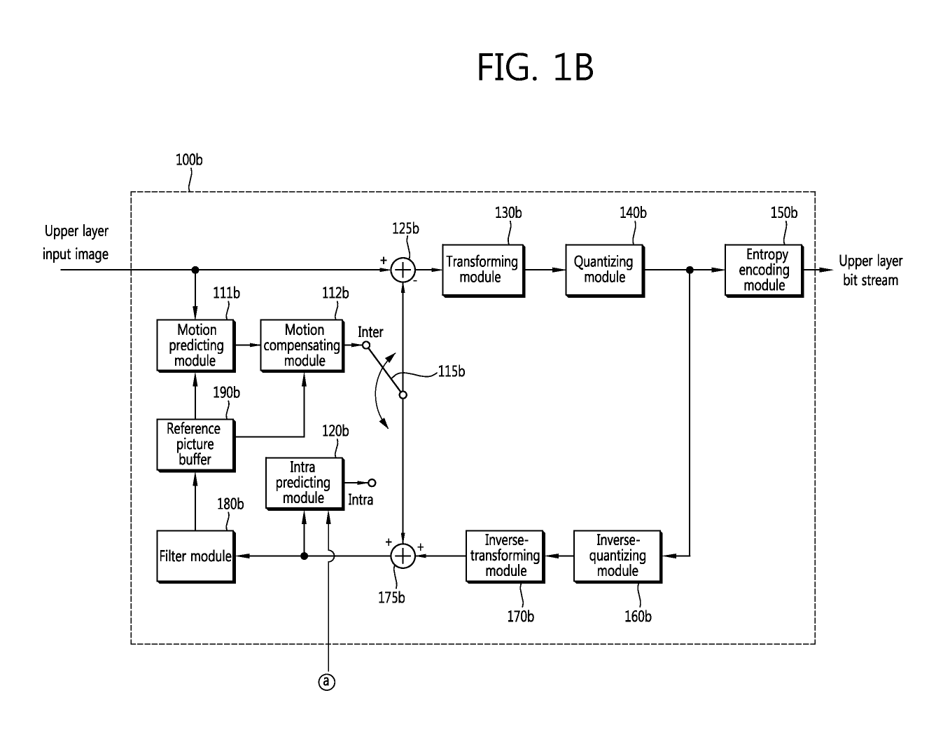

FIGS. 1a and 1b are block diagrams illustrating configurations of image encoding apparatuses according to embodiments of the present invention. An image encoding apparatus according to an embodiment of the present invention includes multiple layer image encoding apparatuses. FIG. 1a is a block diagram illustrating a lower layer image encoding apparatus 100a according to an embodiment of the present invention, and FIG. 1b is a block diagram illustrating an upper-layer image encoding apparatus according to an embodiment of the present invention. An output of the lower layer image encoding apparatus 100a and an output of the upper-layer image encoding apparatus 100b are connected to a multiplexer so that multiple layer bit streams may be combined into a single bit stream. An image encoding apparatus according to another embodiment of the present invention may be configured as the lower layer image encoding apparatus 100a and a plurality of upper-layer image encoding apparatuses 100b depending on the selection, and in some cases, may be configured as a plurality of lower layer image encoding apparatuses 100a and a plurality of upper-layer image encoding apparatuses 100b.

Referring to FIG. 1a, the lower layer image encoding apparatus 100a includes a motion prediction module 111a, a motion compensating module 112a, an intra predicting module 120a, a switch 115a, a subtractor 125a, a transforming module 130a, a quantizing module 140a, an entropy encoding module 150a, an inverse-quantizing module 160a, an inverse-transforming module 170a, an adder 175a, a filter module 180a, and a reference picture buffer 190a.

The lower layer image encoding apparatus 100a performs encoding on a lower layer input image in an intra mode or in an inter mode and may output a lower layer bit stream. The “intra prediction” means intra-frame prediction, and the “inter prediction” means inter-frame prediction. In the intra mode, the switch 115a shifts to intra, and in the inter mode, the switch 115a shifts to inter. The lower layer image encoding apparatus 100a may generate a prediction block for an input block of a lower layer input image and then may encode a residual between the input block and the prediction block.

In the intra mode, the intra predicting module 120a may perform spatial prediction using a pixel value of an already encoded block adjacent to a current block and may generate a prediction block. The intra predicting module 120a may transfer intra prediction mode information to another layer or may receive intra prediction mode information. The intra predicting module 120a of the lower layer image encoding apparatus 100a may selectively transfer the intra prediction mode information of the lower layer block to an intra predicting module 120b of the upper-layer image encoding apparatus 100b pursuant to a request from the intra predicting module 120b of the upper-layer image encoding apparatus 100b (\textcircled{a}). In response, referring to FIG. 1b showing the upper-layer image encoding apparatus 100b, the intra predicting module 120b of the upper-layer image encoding apparatus 100b may receive the intra prediction mode information transmitted from the intra predicting module 120a of the lower layer image encoding apparatus 100a in response to a request (\textcircled{a}) and may selectively use the information to thereby generate a prediction block.

In the inter mode, the motion predicting module 111a (or motion estimator) may obtain a motion vector by figuring out an area that best matches an input block of a reference image stored in the reference picture buffer 190a during the course of motion prediction. The motion compensating module 112a may generate a prediction block by performing motion compensation using the motion vector.

The subtractor 125a may generate a residual block by a residual between the input block and the generated prediction block. The transforming module 130a may perform transform on the residual block to thereby output a transform coefficient. The quantizing module 140a may quantize the input transform coefficient according to a quantization parameter to thereby output a quantized coefficient.

The entropy encoding module 150a may perform entropy encoding based on values produced from the quantizing module 140a (e.g., quantized coefficient) and/or encoding parameters produced during the course of encoding, thereby outputting a lower layer bit stream.

In case entropy encoding applies, a smaller number of bits are assigned to a symbol having a higher chance of occurrence, with a larger number of bits assigned to a symbol having a lower chance of occurrence, and this may result in a decrease in the size of a bit stream for encoding target symbols. Accordingly, image encoding compression performance may be enhanced by entropy encoding. The entropy encoding module 150a may adopt encoding schemes, such as exponential golomb, CAVLC (Context-Adaptive Variable Length Coding), and CABAC (Context-Adaptive Binary Arithmetic Coding), so as to perform entropy encoding.

Since the lower layer image encoding apparatus according to the embodiment of FIG. 1a conducts inter-frame prediction encoding, a currently encoded image needs to be stored while left decoded so that the currently encoded image may be used as a reference image. Thus, the quantized coefficient is inverse-quantized by the inverse-quantizing module 160a and is inverse-transformed by the inverse-transforming module 170a. The inverse-quantized and inverse-transformed coefficient is added to the prediction block by the adder 175a, and a restored block is thereby generated.

The restored block goes through the filter module 180a. The filter module 180a may apply at least one or more of a deblocking filter, an SAO (Sample Adaptive Offset) and ALF (Adaptive Loop Filter) to the restored block or a restored picture. The filter module 180a may also be referred to as an adaptive in-loop filter. The deblocking filter may get rid of a block distortion and/or blocking artifact that is created at a boundary between blocks. The SAO may add a proper offset value to a pixel value to compensate for a coding error. The ALF may perform filtering based on a value obtained by comparing the restored image with an original image. The ALF may be executed only when high efficiency is required. After passing through the filter module 180a, the restored block may be stored in the reference picture buffer 190a.

Referring to FIG. 1b, the upper-layer image encoding apparatus 100b includes a motion predicting module 111b, a motion compensating module 112b, an intra predicting module 120b, a switch 115b, an subtractor 125b, a transforming module 130b, a quantizing module 140b, an entropy encoding module 150b, an inverse-quantizing module 160b, an inverse-transforming module 170b, an adder 175b, a filter module 180b, and a reference picture buffer 190b. The components of the upper-layer image encoding apparatus 100b perform functions respectively corresponding to the components of the lower layer image encoding apparatus 100a.

The upper-layer image encoding apparatus 100b may perform encoding on an upper-layer input image in an intra mode or in an inter mode and may output an upper-layer bit stream. The upper-layer image encoding apparatus 100b may generate a prediction block for an input block of the upper-layer input image and may then encode a residual between the input block and the prediction block.

The intra predicting module 120b may selectively send a request for information of an intra prediction mode to the intra predicting module 120a of the lower layer image encoding apparatus 100a, may receive the intra prediction mode information transmitted from the intra predicting module 120a of the lower layer image encoding apparatus 100a in response to the request (\textcircled{a}), and may selectively use the information to thereby generate a prediction block.

Or depending on selection, the intra predicting module 120b of the upper-layer image encoding apparatus 100b, although not shown in FIG. 1b, may transfer intra prediction mode information of an encoded upper-layer block to an intra predicting unit of another upper-layer image encoding apparatus in response to a request from the intra predicting unit of the other upper-layer image encoding apparatus in the same way as the intra predicting module 120a of the lower layer image encoding apparatus 100a of FIG. 1a.

The entropy encoding module 150b may perform entropy encoding based on values produced from the quantizing module 140b (e.g., quantized coefficient) and/or parameters produced during the course of encoding, thereby outputting an upper-layer bit stream.

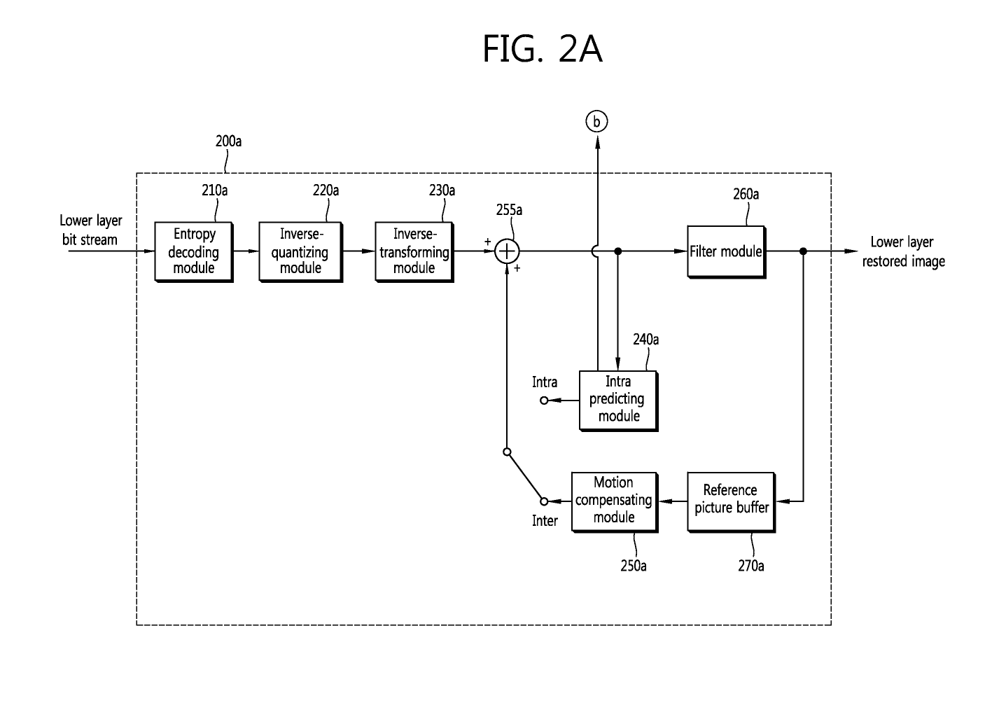

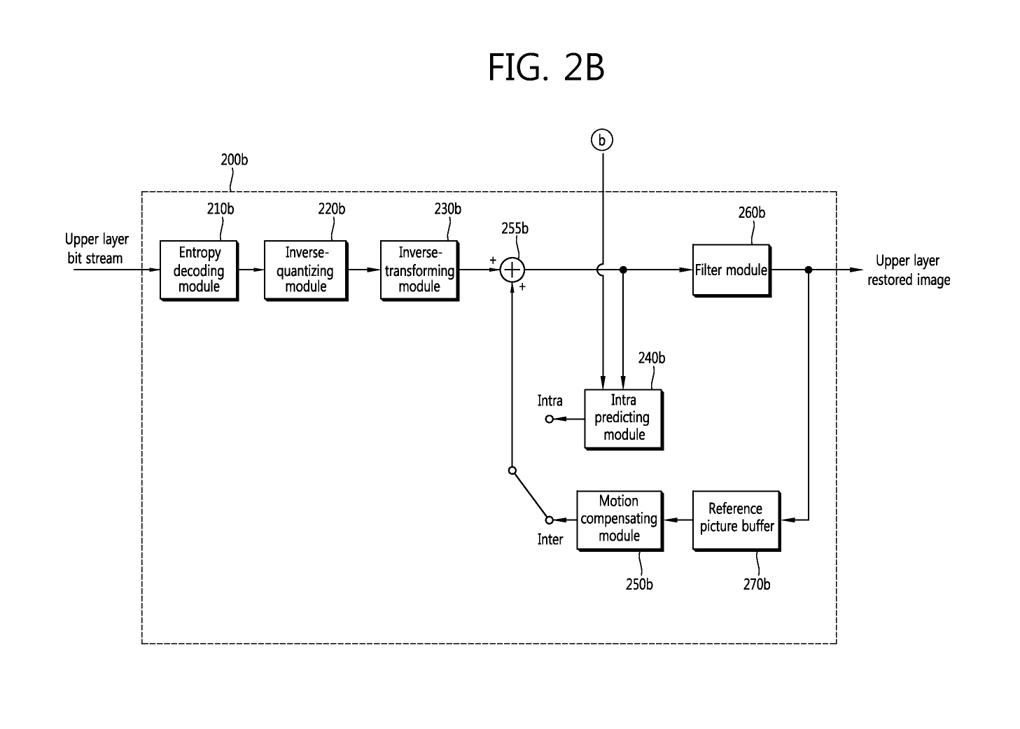

FIGS. 2a and 2b are block diagrams illustrating configurations of image decoding apparatuses according to an embodiment of the present invention. The image decoding apparatus according to an embodiment of the present invention includes multiple layer image decoding apparatuses, and the layer structure of the multiple layer image decoding apparatuses may correspond to the layer structure of the multiple layer image encoding apparatuses.

FIG. 2a is a block diagram illustrating a lower layer image decoding apparatus 200a, and FIG. 2b is a block diagram illustrating an upper-layer image decoding apparatus 200b.

An input of the lower layer image decoding apparatus 200a and an input of the upper-layer image decoding apparatus 200b may be connected to an output of a demultiplexer, so that a single input bit stream may be split into multiple layer bit streams that may be then input to their respective corresponding image decoding apparatuses.

An image decoding apparatus according to another embodiment of the present invention may, depending on selection, consist of a lower layer image decoding apparatus 200a and a plurality of upper-layer image decoding apparatuses 200b or may, in some cases, consist of a plurality of lower layer image decoding apparatuses 200a and a plurality of upper-layer image decoding apparatuses 200b.

Referring to FIG. 2a, the lower layer image decoding apparatus 200a includes an entropy decoding module 210a, an inverse-quantizing module 220a, an inverse-transforming module 230a, an intra predicting module 240a, a motion compensating module 250a, an adder 255a, a filter module 260a, and a reference picture buffer 270a.

The lower layer image decoding apparatus 200a may receive lower layer bit streams output from the encoding apparatus and split through the demultiplexer, may perform decoding on the same in an intra mode or in an inter mode, and may thus output a reconstructed image, i.e., a restored image. In the intra mode, the switch shifts to intra, and in the inter mode, the switch shifts to inter. The lower layer image decoding apparatus 200a may obtain a residual block from the received lower layer bit stream, may generate a prediction block, and may then add the residual block to the prediction block, thereby generating a reconstructed block, i.e., a restored block.

The entropy decoding module 210a may entropy-decode the received lower layer bit stream according to a probability distribution and may thus generate symbols including a symbol that is in the form of a quantized coefficient. An entropy decoding scheme similar to the above-described entropy encoding scheme may be used.

In case the entropy decoding scheme applies, a smaller number of bits are assigned to a symbol having a higher chance of occurrence, while a larger number of bits are assigned to a symbol having a lower chance of occurrence, thus resulting in a decrease in the size of the bit stream for each symbol. Accordingly, compression performance of image encoding may be increased by the entropy decoding scheme.

The quantized coefficient is inverse-quantized by the inverse-quantizing module 220a and inverse-transformed by the inverse-transforming module 230a, and as a result of the inverse quantization/inverse transform of the quantized coefficient, a residual block may be generated.

In the intra mode, the intra predicting module 240a may perform spatial prediction using a pixel value of an already decoded block adjacent to a current block to thereby generate a prediction block. The intra predicting module 240a may transfer intra prediction mode information to another layer or may receive intra prediction mode information. The intra predicting module 240a of the lower layer image decoding apparatus 200a transfers intra prediction mode information of a decoded lower layer block to an intra predicting module 240b of the upper-layer image decoding apparatus 200b in response to a request from the intra predicting module 240b of the upper-layer image decoding apparatus 200b (\textcircled{b}). Referring to FIG. 2b illustrating the upper-layer image decoding apparatus 200b, the intra predicting module 240b may receive the intra prediction mode information transmitted from the intra predicting module 240a of the lower layer image decoding apparatus 200a in response to the request from the upper-layer image decoding apparatus 200b (\textcircled{b}) and may use the information to thereby generate a prediction block.

In the inter mode, the motion compensating module 250a may generate a prediction block by performing motion compensation using a motion vector and a reference image stored in the reference picture buffer 270a.

The residual block and the prediction block are added to each other by the adder 255a, and may then pass through the filter module 260a. The filter module 260a may apply at least one or more of a deblocking filter, an SAO, and an ALF to a restored block or restored picture. The filter module 260a may output a reconstructed image, i.e., a restored image. The restored image may be stored in the reference picture buffer 270a and may be used for inter prediction.

Referring to FIG. 2b, the upper-layer image decoding apparatus 200b includes an entropy decoding module 210b, an inverse-quantizing module 220b, an inverse-transforming module 230b, an intra predicting module 240b, a motion compensating module 250b, an adder 255b, a filter module 260b, and a reference picture buffer 270b. The components of the upper-layer image decoding apparatus 200b respectively correspond to the components of the lower layer image decoding apparatus 200a and may perform functions respectively corresponding to functions of the components of the lower layer image decoding apparatus 200a.

The upper-layer image decoding apparatus 200b may receive upper-layer bit streams output from the encoding apparatus and split through the demultiplexer, may perform decoding on the bit streams in an intra mode or in an inter mode, and may thus output a reconstructed image, i.e., an upper-layer restored image. The upper-layer image decoding apparatus 200b may obtain a residual block from the received upper-layer bit stream, may generate a prediction block, and may add the residual block to the prediction block, thereby generating a reconstructed block, i.e., a restored block.

The entropy decoding module 210b may entropy decode the input upper-layer bit stream according to a probability distribution and may generate symbols including a symbol that is in the form of a quantized coefficient. An entropy decoding scheme similar to the above-described entropy encoding scheme may be used.

In the intra mode, the intra predicting module 240b may generate a prediction block by performing spatial prediction using a pixel value of an already decoded block adjacent to a current block. The intra predicting module 240b may receive intra prediction mode information of another layer and may selectively transfer intra prediction mode information to the other layer. The intra predicting module 240b of the upper-layer image decoding apparatus 200b may receive intra prediction mode information transmitted from the intra predicting module 240a of the lower layer image decoding apparatus 200a (\textcircled{b}) in response to a request and may use the information to thereby generate a prediction block.

Or, although not shown in FIG. 2b, like the intra predicting module 240a of the lower layer image decoding apparatus 200a, the intra predicting module 240b of the upper-layer image decoding apparatus 200b may selectively transfer intra prediction mode information of the decoded upper-layer block to an intra predicting unit of another upper-layer image decoding apparatus in response to a request from the other intra predicting unit of the other upper-layer image decoding apparatus.

Hereinafter, the “block” means a basis for image encoding and decoding. The basis for image encoding and decoding means a unit split from an image, which is subject to encoding or decoding, and may be accordingly referred to as “coding unit (block)” (CB or CB), “prediction unit (block)” (PU or PB), or “transform unit (block)” (TU or TB). One block may be further split into sub blocks having a smaller size. As used herein, the “picture” may be, depending on the situation, replaced with “frame,” “field,” and/or “slice,” and distinction therebetween may be easily made by one of ordinary skilled in the art. For example, the “P picture,” “B picture,” and “forward-directional B picture” may be situationally replaced with the “P slice,” “B slice,” and “forward-directional B slice,” respectively.

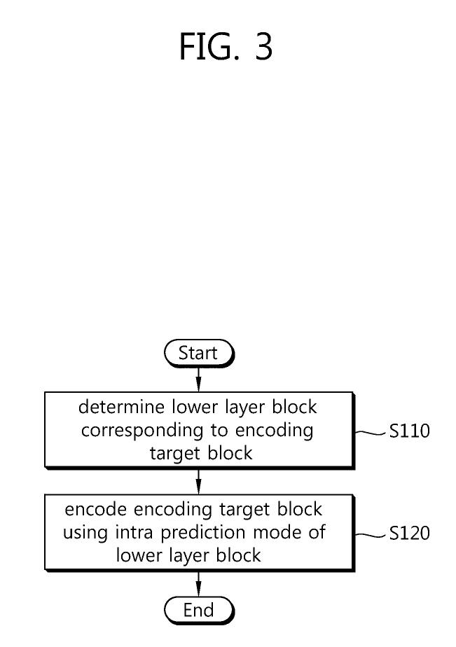

FIG. 3 is a flowchart illustrating a multi-layer structure image encoding method according to an embodiment of the present invention. A multi-layer structure image encoding method according to an embodiment of the present invention is now described.

The multi-layer structure image encoding method according to an embodiment of the present invention shown in FIG. 3 uses information of a lower layer block 410 when performing intra prediction encoding on an upper-layer encoding target block 400. The upper layer may be an enhancement layer, and the lower layer may be a base layer. An upper enhancement layer may use block information of a lower enhancement layer. Further, an enhancement layer may always use block information of a base layer. For example, when there are enhancement layer 1, enhancement layer 2, and enhancement layer 3, the enhancement layer 1, the enhancement layer 2, and the enhancement layer 3 may also use block information of a base layer.

A multi-layer structure image encoding method according to an embodiment of the present invention includes the step S110 of determining a lower layer block corresponding to an upper-layer encoding target block 400 and the step S120 of encoding the encoding target block 400 using an intra prediction mode of the determined lower layer block 410.

In the step S120 of encoding the encoding target block 400, when a corresponding block in the lower layer is unavailable or is inter-prediction encoded, the encoding target block may be encoded in the upper layer through a typical intra prediction scheme. Or, in such case, an intra prediction mode of the corresponding block in the lower layer may be deemed a predetermined intra prediction mode (e.g., DC mode) set by a user according to a setting and may be used for encoding the encoding target block. Or, unlike this, it may be, according to a setting, configured to be performed only when the lower layer block 410 has been encoded in an intra prediction mode.

In the step S120 of encoding the encoding target block 400, the intra prediction mode of the determined lower layer block 410 may be used to generate a prediction signal of the encoding target block 400. Or, the intra prediction mode of the lower layer block 410 may be used as an MPM (Most Probable Mode) candidate mode of the encoding target block 400.

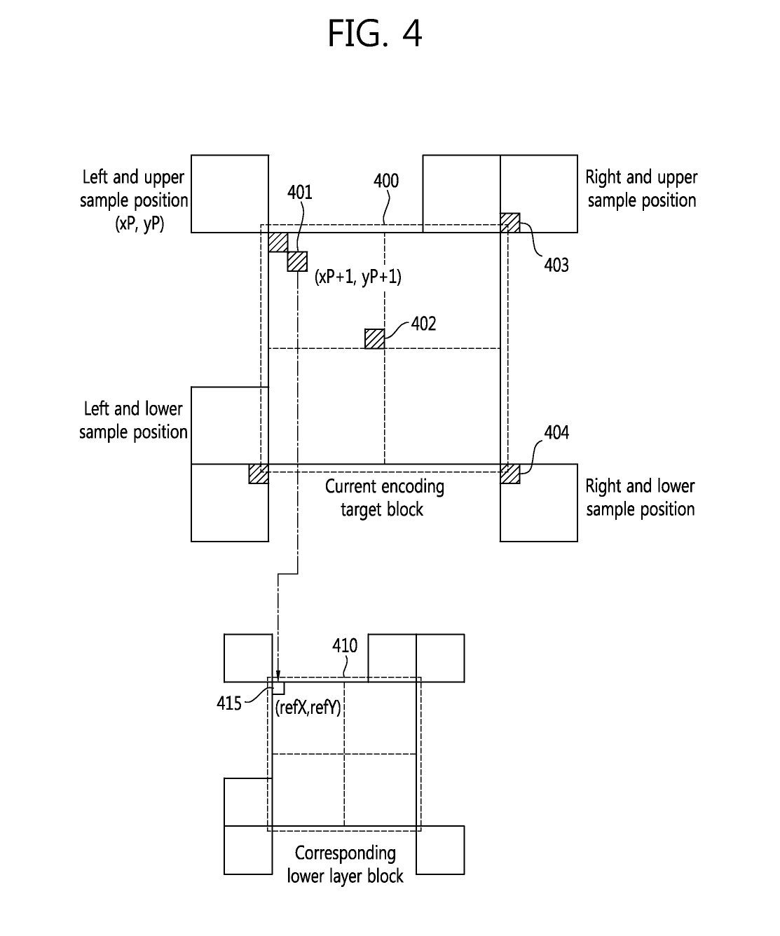

FIG. 4 is a view illustrating a relationship between an encoding target block 400 and a lower layer block 410 corresponding to the encoding target block 400. FIG. 4 illustrates the encoding target block 400 and the lower layer block 410 corresponding to the encoding target block 400.

Referring to FIG. 4, the step S110 of determining the lower layer block 410 corresponding to the upper-layer encoding target block 400 is described. The lower layer block 410 corresponding to the encoding target block 400 may be selected by choosing a block including a sample position of the lower layer block 410 corresponding to a reference sample position of the encoding target block 400. An intra prediction mode of the sample position of the lower layer block corresponding to the reference sample position of the encoding target block may be used as an intra prediction mode of the lower layer block. The reference sample position may use an inner sample position 401 or 402 of the encoding target block 400 as well as sample positions 403 and 404 included in a neighboring block. The sample positions included in the neighboring block may include the right and upper side sample position 403 and the right and lower side sample position 404. The reference sample positions of the encoding target block may use various positions as well as the positions set forth above in the embodiment. In case inter-layer input images are different in size from each other, in obtaining a sample position of a reference layer corresponding to an enhancement layer, a scaling factor between input images may be reflected. The scaling factor between the input images may be determined according to a size ratio between the input images. For example, in case the inter-layer input images have the same size, the scaling factor may be 1, and in case the horizontal/vertical sizes of the enhancement layer, each, are two times larger than each of the horizontal/vertical sizes of the reference layer, the scaling factor may be 2.

Of the inner sample positions shown in FIG. 4, position 401 of (xP+1, yP+1) is described in detail as an example. The reference sample position of the encoding target block 400 is (xP+1, yP+1). At this time, a corresponding sample position (refX, refY) in a lower layer may be calculated according to Equation 1 below. The block including the sample positioned at the calculated sample position (refX, refY) is determined as a block corresponding to the encoding target block 400.

(refX,refY)=(xP+1,yP+1)/Scaling Factor [Equation 1]

“(xP+1, yP+1)/Scaling Factor” may mean dividing each of xP+1 and yP+1 by a scaling factor. In case an input image has a vertical size and a horizontal size different from each other, the horizontal scaling factor may differ from the vertical scaling factor.

In the step S120 of encoding the encoding target block 400, the intra prediction mode of the determined lower layer block 410 may be used to generate a prediction signal of the encoding target block 400. Or, the intra prediction mode of the lower layer block 410 may be used as an MPM (Most Probable Mode) candidate mode of the encoding target block 400.

As described above, the step S120 of the encoding the encoding target block 400 may be performed by generating a prediction signal of the encoding target block 400 using the intra prediction mode of the corresponding lower layer block 410 or by using the intra prediction mode of the corresponding lower layer block 410 as the MPM (Most Probable Mode) candidate mode of the encoding target block 400.

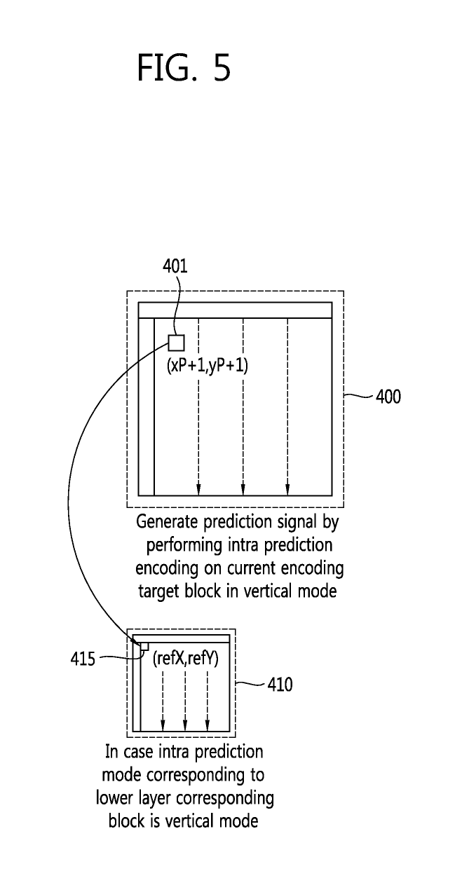

FIG. 5 is a view illustrating generating a prediction signal of the encoding target block 400 using an intra prediction mode of the lower layer block 410. Referring to FIG. 5, the step of encoding the encoding target block 400 by generating a prediction signal of the encoding target block 400 using an intra prediction mode of the lower layer block 410 is described.

FIG. 5 illustrates an example where an intra prediction mode of the corresponding lower layer block 410 is vertical prediction. Referring to FIG. 5, the step of generating a prediction signal of the encoding target block 400 when the intra prediction mode of the lower layer block 410 is vertical prediction.

First, only vertical prediction that is an intra prediction mode of the lower layer block among predetermined intra prediction modes is used to determine a prediction signal from neighboring restored reference samples of the encoding target block 400. Then, transform, quantization, and entropy encoding are performed on a differential signal between an original signal of the encoding target block 400 and a prediction signal generated by the intra prediction mode of the lower layer block 410. Finally, a flag (e.g., base_intra_mode_flag) indicating that the prediction signal of the encoding target block 400 has been generated using the intra prediction mode of the lower layer block 410, other than the transformed and quantized differential signal, is transmitted to the decoding apparatus 200. The size of the flag may be 1 bit. In case the target block is intra prediction encoded by the above-described method, transmission of MPM related syntax information (prev_intra_lum_pred_flag, mpm_idx, rem_intra_luma_pred_mod) used for typical intra prediction mode encoding may be skipped. The decoding apparatus 200 may generate the same prediction signal as that of the encoding apparatus 100 by using only ‘vertical’ prediction that is the intra prediction mode of the lower layer block corresponding to the position of the encoding target block.

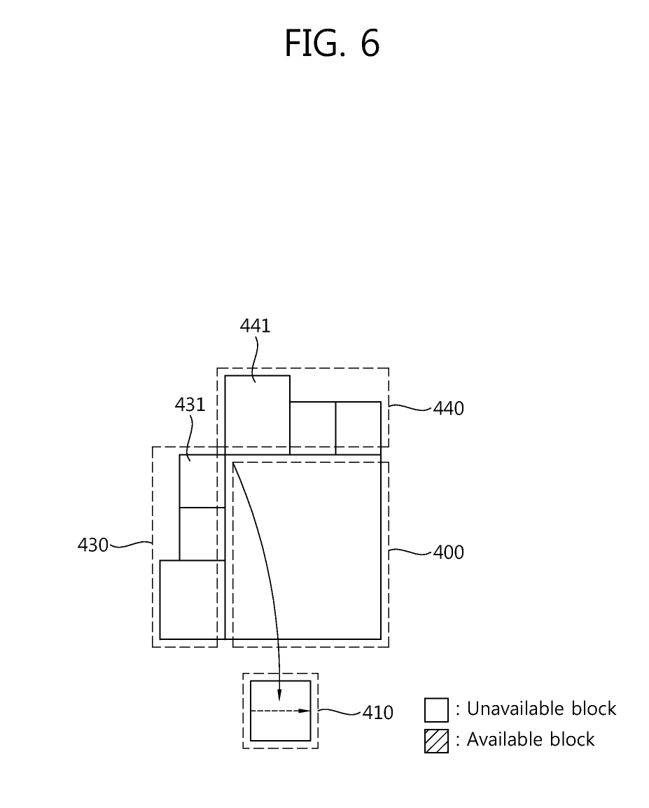

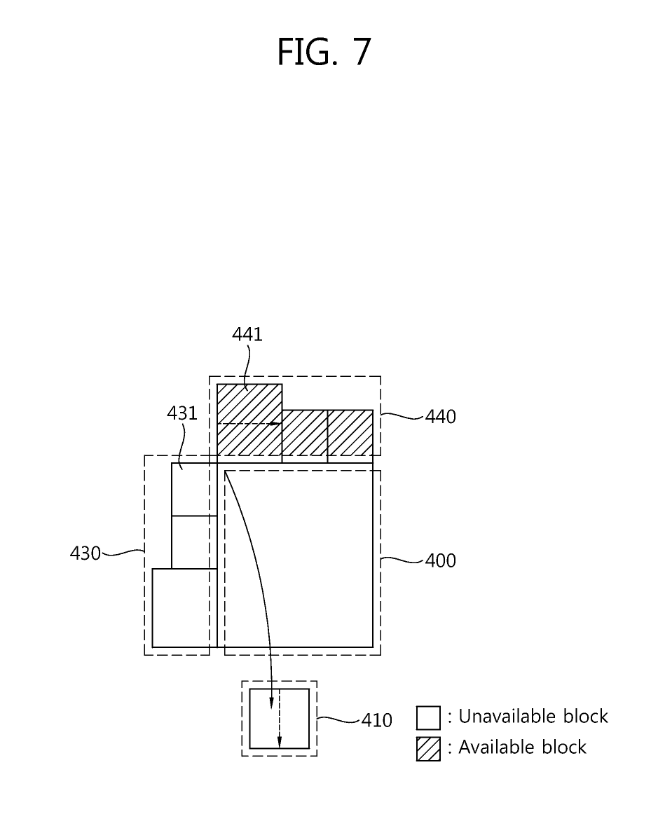

FIGS. 6 to 10 are views illustrating encoding the optimal intra prediction mode of the encoding target block 400 using an intra prediction mode of the corresponding lower layer block 410 as an MPM (Most Probable Mode) candidate mode of the encoding target block 400. FIGS. 6 to 10 illustrate the encoding target block 400, the lower layer block 410 corresponding to the encoding target block 400, left neighboring blocks 430 of the encoding target block 400, and upper neighboring blocks 440 of the encoding target block 400. Blocks that may use information of the corresponding blocks among the neighboring blocks used as MPM candidate modes of the encoding target block 400 are denoted as patternless blocks, and blocks that may not use the information are denoted as blocks with diagonal lines. In an embodiment, FIG. 7 illustrates a block 440 that may use information of the corresponding block and a block 430 that may not use information of the corresponding block.

In case the intra prediction modes of the lower layer blocks 410 are used as MPM candidate modes of the encoding target blocks 400, the encoding apparatus 100 may transmit the flag to the decoding apparatus 200 so that the decoding apparatus may also decode the intra prediction mode of the corresponding block in the same process. For example, the encoding apparatus 100 may transmit a one bit-sized flag indicating that the intra prediction mode of the lower layer block may be used as an MPM candidate mode of the encoding target block 400 through SPS (Sequence Parameter Sets), PPS (Picture Parameter Sets), a slice segment header, an encoding unit or prediction unit to the decoding apparatus 200, so that the decoding apparatus 200 may decode the intra prediction mode of the corresponding block corresponding to the encoding process.

And, the encoding apparatus 100 obtains the optimal prediction mode for the encoding target block 400 among predetermined intra prediction modes and then encodes the optimal prediction mode using the selected MPM candidate mode.

A method of encoding the optimal prediction mode by the encoding apparatus 100 is described. The encoding apparatus 100 transmits a flag (prev_intra_luma_pred_flag) indicating whether the calculated optimal prediction mode is consistent with the MPM candidate mode and index information (mpm_idx) indicating which one of the MPM candidates is consistent with the calculated optimal prediction mode to the decoding apparatus 200. In case none of the MPM candidates are consistent with the calculated optimal prediction mode, the encoding apparatus 100 assigns ‘0’ to the flag (prev_intra_luma_pred_flag) indicating whether the calculated optimal prediction mode is the MPM candidate mode and transmits the flag and directly encodes the optimal prediction mode (rem_intra_luma_pred_mod) of the current block.

Hereinafter, a method of configuring an MPM candidate mode is described with reference to FIGS. 6 to 10. FIG. 6 illustrates an example where information of both neighboring blocks 430 and 440 of the encoding target block 400 may not be used. In the description below, the number of modes included in the MPM candidate modes may be fixed as 2, 3, or 4, and in case it is not filled with the modes, a specific mode may be used as an additional candidate mode. For example, in case the number of modes included in the MPM candidate modes is 3, when candidate mode 1 is different from candidate mode 2, among planar/DC/vertical modes, the DC mode which does not belong to candidate mode 1 and candidate mode 2 may be used as candidate mode 3. At this time, an order in which candidate mode 3 is added may differ from the order of planar/DC/vertical modes and may include a mode other than the planar/DC/vertical modes.

In case candidate mode 1 is the same as candidate mode 2, when candidate modes 1 and 2 are DC or planar modes, candidate mode 1 may be used as a planar mode, candidate mode 2 as a DC mode, and candidate mode 3 as a vertical mode. In case candidate mode 1 is the same as candidate mode 2 while candidate modes 1 and 2 are not DC modes or planar modes, the one smaller mode in mode order with respect to candidate mode 1 or candidate mode 2 may be used as candidate mode 2, and the one larger mode may be used as candidate mode 3.

In case the number of modes included in the MPM candidate modes is 4, the same scheme as applied to the case where the number of the modes is 3 may be performed. For example, the order of priority of modes for determining candidate mode 3 or 4 may be the order of planar/DC/horizontal/vertical modes. As described above, the order of priority may vary, and the modes included in the order of priority may be changed. Further, the order of candidate modes may be changed.

Referring to FIG. 6, an example of using, as an MPM candidate mode, an intra prediction mode of the lower layer block 410 corresponding to the encoding target block 400 in case all the information of neighboring blocks of the encoding target block 400 may not be used is described.

As shown in FIG. 6, the case where information of the neighboring blocks of the encoding target block 400 may not be used may be, for example, when the encoding target block 400 is positioned at a picture boundary, at a slice boundary, or at a tile boundary, so that the information of the neighboring blocks may not be used, when the neighboring blocks are inter-prediction encoded so that the information of the neighboring blocks may not be used, and when the neighboring blocks have the same intra prediction mode. In such case, the intra prediction mode of the lower layer block 410 may be used as an MPM candidate mode.

At this time, in case neither information of a left neighboring block 430 nor information of an upper neighboring block 440 used as MPM candidate modes of the encoding target block 400 is available, a specific mode of predetermined intra prediction modes may be selected, and the selected mode, together with the intra prediction mode of the lower layer block 410, may be used as an MPM candidate mode. For example, of predetermined intra prediction modes, a planar mode may be used as MPM candidate mode 1, and a horizontal mode, which is an intra prediction mode of the lower layer block 410, may be used as MPM candidate mode 2. Or, of prediction modes, a DC mode may be used as MPM candidate mode 1, and a horizontal mode that is an intra prediction mode of the lower layer block 410 may be used as MPM candidate mode 2.

FIG. 7 is a view illustrating an example where information of a left neighboring block 430 used as an MPM candidate mode of the encoding target block 400 is not available. Referring to FIG. 7, an example is described where, in case information of only one of the left neighboring block 430 and the upper neighboring block 440 is available, the available left or upper intra prediction mode and the intra prediction mode of the lower layer block 410 are used as MPM candidate modes is described.

In the embodiment illustrated in FIG. 7, the information of only the upper neighboring blocks 440 of the encoding target block 400 is available. The upper prediction mode of the leftmost block 441 of the upper neighboring blocks 440 and the intra prediction mode of the lower layer block 410 may be used as MPM candidate modes. For example, the upper prediction mode of the leftmost block 441 of the upper neighboring blocks 440 may be used as MPM candidate mode 1, and the intra prediction mode of the lower layer block 410 may be used as MPM candidate mode 2. If the intra prediction mode of the leftmost block 441 of the upper neighboring blocks 440 is a horizontal mode and if the intra prediction mode obtained from the lower layer block 410 is a vertical mode, MPM candidate mode 1 may be a horizontal mode, and MPM candidate mode 2 may be a vertical mode.

In another embodiment, in case the information of the upper neighboring block 440 is not available while the information of the left neighboring block 430 is available, the intra prediction modes of the left neighboring block 430 and the lower layer block 410 may be used as MPM candidate modes. In such case, the same scheme as using an upper prediction mode of the upper neighboring block 440 and an intra prediction mode of the lower layer block 410 as MPM candidate modes may be performed.

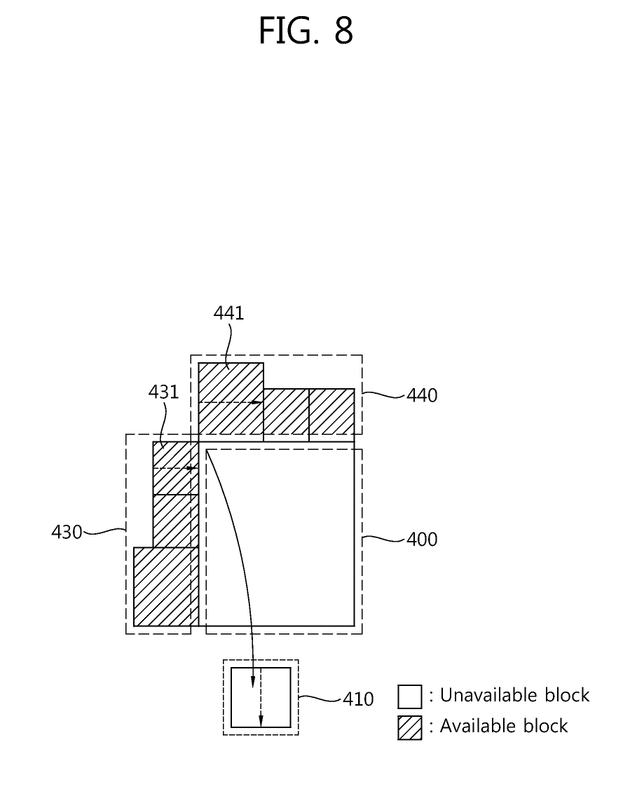

FIG. 8 is a view illustrating an example where information of the uppermost block 431 of the left neighboring blocks 430 and information of the leftmost block 441 of the upper neighboring blocks 440 which are used as MPM information are identical to each other. In case the information of the left neighboring blocks 430 and the information of the upper neighboring blocks 440 used as MPM information of the encoding target block 400 are the same, the intra prediction mode of one of the left neighboring blocks 430 or the upper neighboring blocks 440 and the intra prediction mode of the lower layer block 410 may be used as MPM candidate modes.

In the embodiment of FIG. 8, the intra prediction modes of the uppermost block 431 of the left neighboring blocks 430 and the leftmost block 441 of the upper neighboring blocks 440 have horizontal modes as their values. Hereinafter, it is assumed that the intra prediction mode of the left neighboring blocks 430 is obtained from the uppermost block 431, and the intra prediction mode of the upper neighboring blocks 440 is obtained from the leftmost block 441.

The intra prediction mode of the lower layer block 410 is a vertical mode. In such case, the horizontal mode, which is the intra prediction mode of the upper neighboring block 440 may be determined as MPM candidate mode 1, and the vertical mode which is the intra mode of the lower layer block 410 may be determined as MPM candidate mode 2. Likewise, a method of determining the value of the left neighboring block 430 as MPM candidate mode 1 may be also considered.

When the intra prediction mode of the lower layer block 410 has the same value as the intra prediction mode of the upper neighboring block 440 or the intra prediction mode of the left neighboring block 430, the intra prediction mode information obtained from the lower layer block 410 may not be used. In such case, the intra prediction modes of the upper neighboring blocks 440 and the left neighboring blocks 430 are determined and used as MPM candidate mode 1 and MPM candidate mode 2, while the information of the lower layer block may not be used. The mode of a neighboring block having the same mode as the intra mode of the lower layer block may be also determined and used as MPM candidate mode 2. In addition, it may be selectively denoted that the intra prediction mode of the lower layer block has not been used as the MPM candidate mode of the encoding target block 400.

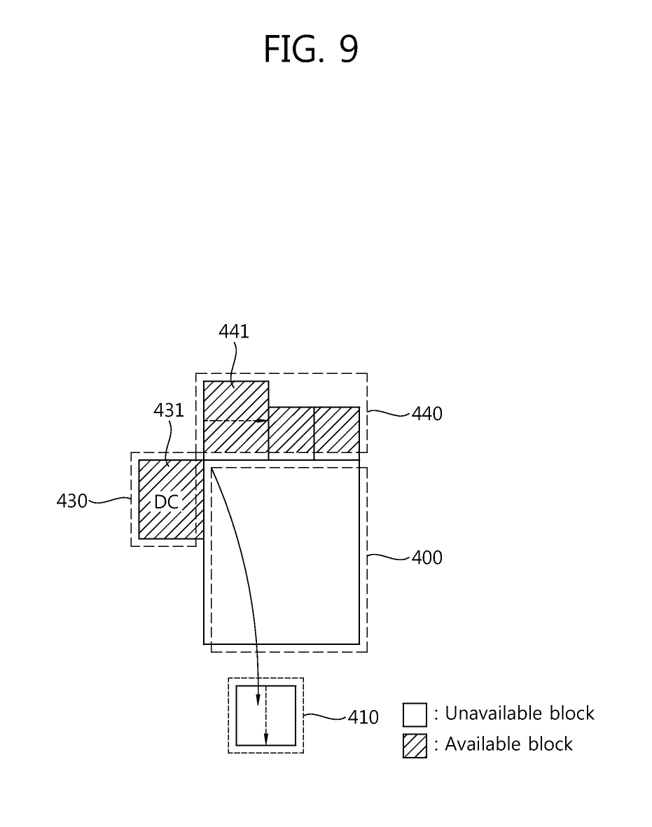

FIG. 9 is a view illustrating an example where the intra prediction mode values of the upper neighboring blocks 440 of the encoding target block 400 are different from the intra prediction mode values of the left neighboring blocks 430 of the encoding target block 400. Referring to FIG. 9, a step of determining an MPM candidate mode is described, with at least one of MCM candidates obtained from the upper neighboring blocks 440 and the left neighboring blocks 430 replaced with the intra prediction mode obtained from the lower layer block 410.

In an inter-layer prediction method of an image signal according to an embodiment of the present invention, one of MCM candidates obtained from neighboring blocks of the encoding target block 400 may be replaced with the intra prediction mode obtained from the lower layer block 410.

In the embodiment of FIG. 9, the intra prediction modes of the upper neighboring blocks 440 of the encoding target block 400 are horizontal modes, and the intra prediction modes of the left neighboring blocks 430 are DC modes. The intra prediction mode of the lower layer block 410 of the encoding target block 400 is a vertical mode.

In the embodiment of FIG. 9, MPM candidate modes may be determined with horizontal modes, which are intra prediction modes of the upper neighboring blocks 440, set as MPM candidate mode 1 and DC modes, which are intra prediction modes of the left neighboring blocks 430, set as MPM candidate mode 2, from the surroundings of the encoding target block 400. At this time, MPM candidate mode 2 may be replaced with a vertical mode that is an intra prediction mode of the lower layer block 410. That is, MPM candidate mode 1 may have a horizontal mode, and MPM candidate mode 2 may have a vertical mode.

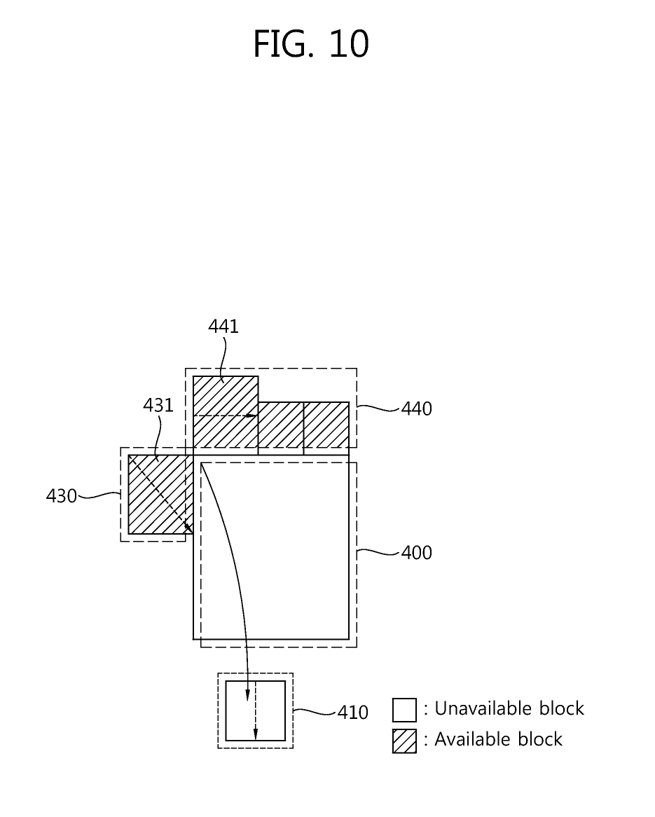

FIG. 10 is a view illustrating an example where the intra prediction mode values of the upper neighboring blocks 440 of the encoding target block 400 are different from the intra prediction mode values of the left neighboring blocks 430 of the encoding target block 400. Referring to FIG. 10, a step is described of using the intra prediction mode obtained from the lower layer block 410 as an additional MPM mode.

In an inter-layer prediction method of an image signal according to an embodiment of the present invention, an intra prediction mode obtained from the lower layer block 410 may be used as an additional MPM mode. Accordingly, the MPM candidate mode obtained from the lower layer block 410 may be added to the MPM candidate modes obtained from the neighboring blocks of the encoding target block 400.

In the embodiment of FIG. 10, the intra prediction modes of the upper neighboring blocks 440 of the encoding target block 400 are horizontal modes, and the intra prediction modes of the left neighboring blocks 430 are VER-8 modes. The intra prediction mode of the lower layer block 410 of the encoding target block 400 is a vertical mode.

In the embodiment of FIG. 10, MPM candidate modes may be determined, with horizontal modes that are intra prediction modes of the upper neighboring blocks 440 set as MPM candidate mode 1 and VER-8 modes that are intra prediction modes of the left neighboring blocks 430 set as MPM candidate mode 2, from the surroundings of the encoding target block 400. At this time, the vertical mode that is an intra prediction mode of the lower layer block 410 may be added and used as MPM candidate mode 3. In other words, the MPM candidate modes for the encoding target block 400 consist of three candidate modes, with MPM candidate modes 1, 2, and 3 having a horizontal mode, VER-8 mode, and vertical mode, respectively.

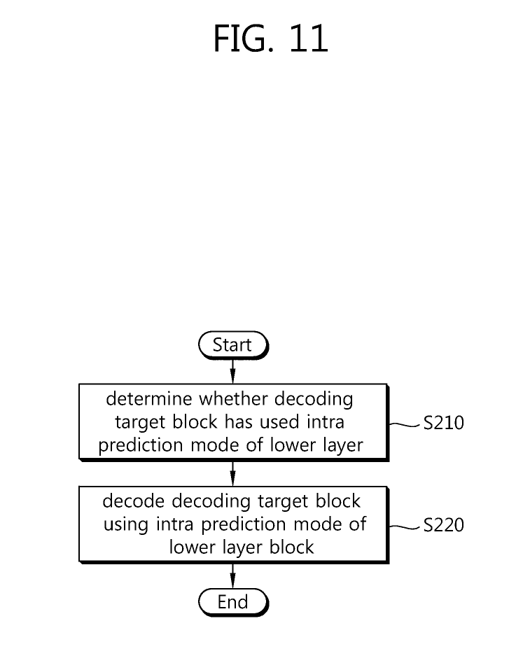

FIG. 11 is a flowchart illustrating a multi-layer structure image decoding method according to an embodiment of the present invention. Hereinafter, a multi-layer structure image decoding method according to an embodiment of the present invention is described.

The multi-layer structure image decoding method according to an embodiment of the present invention as shown in FIG. 11 uses information of the lower layer block 410 when performing intra prediction encoding on an upper-layer decoding target block. According to an embodiment of the present invention, the multi-layer structure image decoding method includes the step S210 of determining whether the decoding target block has been encoded using a lower layer intra prediction mode and the step S220 of decoding the decoding target block using an intra prediction mode of the lower layer block 410 corresponding to the decoding target block.

The step S220 of decoding the decoding target block using the intra prediction mode of the lower layer block 410 corresponding to the decoding target block may be performed by generating a prediction signal of the decoding target block using the intra prediction mode of the corresponding lower layer block 410. Or, the step S220 may be also carried out by using the intra prediction mode of the corresponding lower layer block 410 as an MPM (Most Probable Mode) candidate mode of the current encoding target prediction block.

The step S210 is described of determining whether the decoding target block has been encoded using the intra prediction mode of the lower layer block 410. The intra predicting module 240 of the decoding apparatus 200 may determine whether the decoding target block has been encoded using the intra prediction mode of the lower layer block 410 through a flag determining whether the decoding target block has used the lower layer intra prediction mode.

That is, the decoding apparatus 200 may determine whether the decoding target block has been encoded using information of the lower layer block 410 by parsing the flag determining whether the decoding target block has used the intra prediction mode of the lower layer block 410 corresponding to the decoding target block.

In an embodiment of the present invention, the decoding apparatus 200 may determine whether a decoding target block has been intra prediction encoded using intra information of the lower layer block 410 by parsing, e.g., base_intra_mode_flag transmitted from the encoding apparatus 100. At this time, if the corresponding flag is 1, the decoding target block may be determined to have been intra prediction encoded using the intra prediction mode of the lower layer block 410, and if the corresponding flag is 0, the decoding target block may be determined to have been intra prediction encoded without using the intra prediction mode of the lower layer block 410. In such case, additional flags (prev_intra_luma_pred_flag, mpm_idx, rem_intra_luma_pred_mod) additionally indicating the intra prediction mode may be parsed. In an embodiment of the present invention, the decoding apparatus 200 may determine whether to have used the intra prediction mode of the lower layer block when determining the MPM candidate mode of the decoding target block by parsing, e.g., base_intra_mode_prediction_flag, transmitted from the encoding apparatus 100 through SPS, PPS, and slice segment header. At this time, if the corresponding flag is 1, the decoding target block may be determined to have determined the MPM candidate mode using the intra prediction mode of the lower layer block 410, and if the corresponding flag is 0, the decoding target block may be determined to have determined the MPM candidate mode from the left block and upper block of the current decoding target block without using the intra prediction mode of the lower layer block 410.

A process in which the step S220 of decoding the decoding target block using the intra prediction mode of the lower layer block 410 corresponding to the decoding target block is performed by generating a prediction signal of the decoding target block using the intra prediction mode of the corresponding lower layer block 410 is now described.

In case, e.g., base_intra_mode_flag, transmitted from the encoding apparatus 1000 is 1, that is, when the flag indicating that the prediction signal of the encoding target block 400 is generated using the intra prediction mode of the lower layer block 410 is 1, the decoding apparatus 200 determines that the decoding target block is decoded by the method of generating the prediction signal of the encoding target block 400 using the lower layer intra prediction mode. The decoding apparatus 200 may generate the prediction signal of the current decoding target block using the intra prediction mode of the lower layer block 410 corresponding to the decoding target block. The step of obtaining the corresponding lower layer block 410 by the decoding apparatus 200 and the process of generating the prediction signal of the current decoding target block using the intra prediction mode are performed to correspond to the step of determining the lower layer block 410 corresponding to the encoding target block 400 by the encoding apparatus 100 and generating the intra prediction mode of the encoding target block 400 using the intra mode of the determined lower layer block 410.

The decoding apparatus 200 may select a lower layer block corresponding to the decoding target block by selecting a block including the sample position of the lower layer block 410 corresponding to the reference sample position of the decoding target block, and in such case, may select a scaling factor between input images as in the encoding apparatus 100. Further, the decoding apparatus 200 generates a prediction signal of the decoding target block using the intra prediction mode of the corresponding lower layer block 410. Next, the decoding apparatus 200 generates a restored signal of the current target block by adding the generated prediction signal to a residual signal that has been transmitted from the encoding apparatus 100 and that has been restored.

Finally, a process of decoding the decoding target block using, as an MPM (Most Probable Mode) candidate mode of the current decoding target prediction block, the intra prediction mode of the corresponding lower layer block 410 by the decoding apparatus 200 in the step of decoding the decoding target block using the intra prediction mode of the lower layer block 410 corresponding to the decoding target block is described.

In case the flag indicating that the intra prediction mode of the lower layer block 410 is used as an MPM candidate mode of the encoding target block 400 is 1, that is, when the one bit-sized flag (e.g., base_intra_mode_prediction_flag) is 1, the decoding apparatus 200 determines that the decoding target block has been decoded using the intra prediction mode of the lower layer block 410 as the MPM candidate mode.

The step of obtaining the corresponding lower layer block 410 may adopt the above-described method. Further, the process of generating the MPM candidate mode of the decoding target block may be performed corresponding to the process of generating the MPM candidate mode in the encoding apparatus 100.

For example, in case no intra modes may be used from the left neighboring blocks 430 and upper neighboring blocks 440 of the decoding target block, a predetermined intra prediction mode may be used as MPM candidate mode 1, and an intra prediction mode of the corresponding lower layer block 410 may be used as MPM candidate mode 2.

Further, in case the intra mode information of only one of the left neighboring blocks 430 and the upper neighboring blocks 440 of the decoding target block is available, the intra prediction mode of the available neighboring block may be used as MPM candidate mode 1, and the intra prediction mode of the corresponding lower layer block 410 may be used as MPM candidate mode 2.

Further, in case the intra mode information may be available from the left neighboring blocks 430 and the upper neighboring blocks 440 of the decoding target block, the intra mode having a smaller mode number of the two intra modes may be used as MPM candidate mode 1, and the intra prediction mode of the corresponding lower layer block 410 may be used as MPM candidate mode 2 replacing the intra information of the neighboring block. Or, the two intra modes may be used as MPM candidate mode 1, the other one intra mode as MPM candidate mode 2, and the intra prediction mode of the corresponding lower layer block 410 as MPM candidate mode 3. Further, in case the number of modes included as MPM candidate modes is defined as 3 or 4, additional candidates may be generated and used according to the predefined rule.

After the MPM candidate modes are generated, it is determined which one of the MPM candidates is the optimal prediction mode using the flag (prev_intra_luma_pred_flag) indicating whether the optimal prediction mode is consistent with the MPM candidate. In case prev_intra_luma_pred_flag is 1, index information (mpm_idx) indicating which one of the MPM candidates is consistent with it may be parsed to obtain the optimal prediction mode of the MPM candidate modes. In case prev_intra_luma_pred_flag is 0, rem_intra_luma_pred_mod may be decoded to obtain the optimal prediction mode.

Although in the above-described embodiments, images having a first layer and a second layer are described as an example, the same method may be applicable to images having more layers. The combinations of the above-described embodiments are not limited to what is described above, and various combinations may be also provided in addition to the above-described embodiments depending on implementations and/or demands.

In the above-described embodiments, the methods are described based on flowcharts including a series of steps or blocks, but the methods are not limited to the order of the steps, and some steps may be performed in a different order or simultaneously with other steps. Further, it may be understood by those skilled in the art that without the steps provided in the flowcharts being excluded from each other, other steps may be added and some of the steps in the flowcharts may be deleted without affecting the scope of the invention.

The above-described embodiments include various aspects of examples. Although all possible combinations of the various aspects cannot be described, it may be recognized by those skilled in the art that other combinations may be made. Accordingly, the present invention includes all other changes, modifications, and variations as belonging to the scope of the appending claims.

1. A multi-layer structure image decoding method, wherein the multi-layer structure having a first layer including a current encoding target block and a second layer that is a layer lower than the first layer, the method comprising the steps of:
determining a corresponding block in the second layer corresponding to the encoding target block; and
encoding the encoding target block using an intra prediction mode of the corresponding block in the second layer.

2. The multi-layer structure image encoding method of claim 1, wherein the step of encoding the encoding target block generates a prediction signal of the encoding target block using the intra prediction mode of the corresponding block in the second layer.

3. The multi-layer structure image encoding method of claim 1, wherein the step of encoding the encoding target block uses the intra prediction mode of the corresponding block in the second layer as an MPM (Most Probable Mode) candidate mode of the encoding target block.

4. A multi-layer structure image decoding method, wherein the multi-layer structure having a first layer including a current decoding target block and a second layer that is lower than the first layer, the method comprising the step of decoding the decoding target block using an intra prediction mode of the second layer block.

5. The multi-layer structure image decoding method of claim 4, wherein the multi-layer structure image decoding method specifies a corresponding block in the second layer by specifying a sample position of the second layer corresponding to a reference sample position of the decoding target block using a scaling factor between input images.

6. The multi-layer structure image decoding method of claim 4, wherein the step of decoding the decoding target block further includes the step of determining whether the decoding target block has used the intra prediction mode of the second layer block, wherein the decoding step decodes the decoding target block using the intra prediction mode of the second layer in a case where the decoding target block has used the intra prediction mode of the second layer.

7. The multi-layer structure image decoding method of claim 4, wherein the step of decoding the decoding target block generates a prediction signal of the decoding target block using the intra prediction mode of the second layer block.

8. The multi-layer structure image decoding method of claim 4, wherein the step of decoding the decoding target block uses the intra prediction mode of the second layer block as an MPM (Most Probable Mode) candidate mode of the decoding target block.

9. The multi-layer structure image decoding method of claim 8, wherein the step of decoding the decoding target block replaces at least one of an intra mode of an upper neighboring block or a left neighboring block with the intra prediction mode of the second layer block.

10. The multi-layer structure image decoding method of claim 8, wherein the step of decoding the decoding target block uses intra modes of the upper neighboring block and the left neighboring block of the decoding target block and the intra prediction mode of the second layer block as MPM candidate modes.

11. (canceled)

12. A multi-layer structure image encoding apparatus, wherein the multi-layer structure having a first layer including a current encoding target block and a second layer that is lower than the first layer, the apparatus comprising an intra predicting unit that encodes the encoding target block using an intra prediction mode of the second layer block.

13. The multi-layer structure image encoding apparatus of claim 12, wherein the intra predicting unit generates a prediction signal of the encoding target block using the intra prediction mode of the second layer block.

14. The multi-layer structure image encoding apparatus of claim 12, wherein the intra predicting unit uses the intra prediction mode of the second layer block as an MPM (Most Probable Mode) candidate mode of the encoding target block.

15. A multi-layer structure image decoding apparatus, wherein the multi-layer structure having a first layer including a current decoding target block and a second layer that is lower than the first layer, the apparatus comprising an intra predicting unit that decodes the decoding target block using an intra prediction mode of the second layer block.

16. The multi-layer structure image decoding apparatus of claim 15, wherein the intra predicting unit specifies a second layer block corresponding to the decoding target block by specifying a sample position of the second layer corresponding to a reference sample position of the decoding target block using a scaling factor between input images.

17. The multi-layer structure image decoding apparatus of claim 15, wherein the intra predicting unit generates a prediction signal of the decoding target block using the intra prediction mode of the second layer block.

18. The multi-layer structure image decoding apparatus of claim 15, wherein the intra predicting unit uses the intra prediction mode of the second layer block as an MPM (Most Probable Mode) candidate mode of the decoding target block.

19. The multi-layer structure image decoding apparatus of claim 18, wherein the intra predicting unit replaces at least one of intra modes of an upper neighboring block and a left neighboring block of the decoding target block with the intra prediction mode of the second layer block.

20. The multi-layer structure image decoding apparatus of claim 18, wherein the intra predicting unit uses the intra modes of the upper neighboring block and the left neighboring block of the decoding target block and the intra prediction mode of the second layer block as MPM candidate modes.
